(19) United States
(12) Patent Application Publication
(10) Pub. No.: US 2026/0236072 A1
(43) Pub. Date: Aug. 13, 2026

(54) STORAGE APPARATUS, METHOD FOR CONTROLLING STORAGE APPARATUS, AND PROGRAM

(71) Applicant: Hitachi Vantara, Ltd., Yokohama-shi (JP)

(72) Inventors: Sho IKEDA, Yokohama-shi (JP); Naoki WADA, Yokohama-shi (JP); Kengo OTANI, Yokohama-shi (JP); Tsubasa MATSUSHITA, Yokohama-shi (JP)

(73) Assignee: Hitachi Vantara, Ltd, Yokohama-shi (JP)

(21) Appl. No.: 19/330,357

(22) Filed: Sep. 16, 2025

(30) Foreign Application Priority Data
Feb. 13, 2025 (JP) 2025-021231

(51) Int. Cl. G06F 1/20; G06F 1/18; G11B 33/14

(52) U.S. Cl. CPC G06F 1/20; G06F 1/189; G11B 33/142

(57) ABSTRACT

A storage apparatus includes a housing (control unit) that houses components, a plurality of cooling fans provided at a plurality of locations of the housing so as to cool at least one of the components, and an information processing device (control microcomputer) configured to control the plurality of cooling fans. The information processing device acquires environment information that is information (output of temperature sensor) on an environment inside or around the housing, and controls rotation speeds of the cooling fans based on the environment information and positions where the cooling fans are provided.

### BACKGROUND OF THE INVENTION

### 1. Field of the Invention

The present invention relates to a storage apparatus, a method from controlling the storage apparatus, and a program.

### 2. Description of Related Art

PTL 1 discloses a disk array device configured for the purpose of providing an efficient structure in consideration of high-density mounting and cooling performance. The disk array device has a basic housing to which a backboard is fixed. An HDD module and the like are mounted on a front portion of the backboard from a front surface, double CTL modules are mounted vertically on a rear portion from the rear surface, and double power supply modules with built-in fans are mounted on the left and the right. By operating the fans, in the rear portion, a part of cooling air flows into the CTL modules and the other flows into the power supply modules, and the cooling air passing through a region of a duct by a block in the CTL modules is suctioned by the fans in the power supply modules from a vent hole or the like and is discharged to the outside. The cooling air branches into cooling air flow paths to a plurality of ICs and the like by blocks. The disk array device controls fan rotation using a temperature sensor.

### CITATION LIST

### Patent Literature

PTL 1: U.S. Pat. No. 7,593,225B

### SUMMARY OF THE INVENTION

A large number of electronic components are mounted on a storage apparatus. In order to cool these components, a plurality of cooling fans are mounted inside a housing of the storage apparatus. In recent years, a higher cooling capability has been required for a cooling fan mounted inside a housing along with an increase in density and heat generation of a storage apparatus. Cooling performance of a cooling fan improves as a rotation speed increases, but power consumption and noise increase as the rotation speed increases.

In the disk array device disclosed in PTL 1, a plurality of cooling fans are uniformly controlled according to a detection value of a temperature sensor provided at a predetermined position of a housing. Therefore, there is a problem that the plurality of cooling fans are wasted as a whole, and power consumption and noise increase.

The invention is made based on such a background, and an object of the invention is to provide a storage apparatus, a method for controlling the storage apparatus, and a program, that can efficiently control a plurality of cooling fans provided in the storage apparatus.

In order to achieve the above object, an aspect of the invention provides a storage apparatus that inputs and outputs data to and from a memory drive in response to an input and output request transmitted from an external apparatus. The storage apparatus includes: a housing configured to house components of the storage apparatus; a plurality of cooling fans provided at a plurality of locations of the housing so as to cool at least one of the components; and an information processing device configured to control the plurality of cooling fans. The information processing device acquires environment information that is information on an environment inside or around the housing, and controls rotation speeds of the cooling fans based on the environment information and positions where the cooling fans are provided.

Problems, configurations, and effects other than those described above will become apparent in the following description of the embodiment of the invention.

According to the invention, a plurality of cooling fans provided in a storage apparatus can be efficiently controlled.

### BRIEF DESCRIPTION OF THE DRAWINGS

FIG. 1 is a diagram illustrating an example of a storage system;

FIG. 2A is a plan view illustrating a configuration of a control device;

FIG. 2B is a perspective view illustrating a configuration of the control device;

FIG. 3 is a diagram illustrating a main connection relationship around a control microcomputer;

FIG. 4 is a diagram illustrating an example of group classification of cooling fans;

FIG. 5 illustrates an example of rotation speed setting information;

FIG. 6A is a diagram illustrating a schematic flow of intake air and exhaust air of cooling air;

FIG. 6B is a diagram illustrating a relative strength of cooling air generated by each cooling fan;

FIG. 7 is a diagram illustrating a state in which two control units are stacked vertically;

FIG. 8 is a diagram illustrating control level switching control;

FIG. 9A is a flowchart illustrating fan control processing;

FIG. 9B is a flowchart illustrating low-speed processing;

FIG. 9C is a flowchart illustrating medium-speed processing;

FIG. 9D is a flowchart illustrating high-speed processing;

FIG. 9E is a flowchart illustrating ultrahigh-speed processing; and

FIG. 9F is a flowchart illustrating power failure processing.

### DESCRIPTION OF EMBODIMENTS

Hereinafter, embodiments of the invention will be described with reference to the drawings. The following embodiments are merely examples for describing the invention, and are omitted and simplified as appropriate for clarity of the description.

The invention can be implemented in various other forms. Unless otherwise specified, each component may be single or plural.

In the following description, when there are a plurality of components having a common function, different subscripts may be added to the same reference numerals in order to distinguish the components. In addition, when it is not necessary to distinguish the plurality of components from one another, the subscripts may be omitted.

In the following description, processing executed by an information processing device (a calculation device, a computer) executing a program may be described. Note that an execution body of a program may be any execution body that functions at least as a calculation unit, and examples of the execution body include a processor (such as a central processing unit (CPU), a micro processing unit (MPU), and a graphics processing unit (GPU)). The execution body of a program may be, for example, an application specific integrated circuit (ASIC), a field programmable gate array (FPGA), and a complex programmable logic device (CPLD).

In the following description, an input and output (input/output) may be referred to as an “I/O”, and an interface may be referred to as an “I/F”.

In the following description, a letter “S” added before a reference sign refers to a processing step.

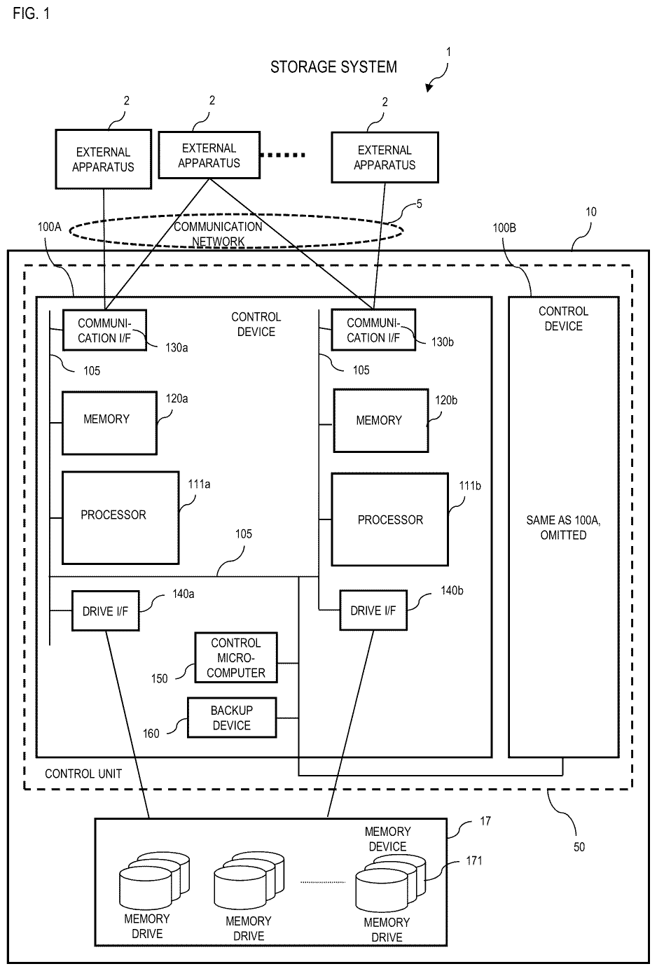

FIG. 1 illustrates a schematic configuration of a storage system 1 according to an embodiment. The storage system 1 includes external apparatuses 2 (also referred to as “upper level apparatus”, “server apparatus”, “host apparatus”, or the like), a communication network 5, and a storage apparatus 10.

The external apparatuses 2 are communicably connected to the storage apparatus 10 via the communication network 5. Examples of the communication network 5 include a local area network (LAN), a wide area network (WAN), a storage area network (SAN), and the Internet.

The external apparatus 2 is an information processing apparatus (computer) that uses a memory area provided by the storage apparatus 10 via the communication network 5 as a storage (memory) location of data. Examples of the external apparatus 2 include a personal computer, an office computer, a mainframe, a smartphone, and a tablet.

The storage apparatus 10 includes two control devices 100 (control device 100A and control device 100B) and a memory device 17. The control device 100A and the control device 100B are provided in a housing (control unit 50 to be described later) of the storage apparatus 10.

When the external apparatus 2 accesses the memory area, the external apparatus 2 transmits a data I/O request (data write request for writing data to the memory device 17 and data read request for reading data from the memory device 17) to the storage apparatus 10.

Note that the control device 100A and the control device 100B have a common basic configuration, and components having the same names have the same functions. Therefore, in the following, in order to avoid redundant description, the control device 100A will be described when a configuration common to both control devices is described.

The control device 100A includes a processor 111a, a memory module 120a, a communication I/F 130a, and a drive I/F 140a. These components are communicably connected to one another via a bus 105 (for example, peripheral component interconnect-express (PCIe) bus).

As illustrated in the drawing, a control microcomputer 150 and a backup device 160 are connected to the bus 105. A processor 111b, a memory module 120b, a communication I/F 130b, and a drive I/F 140b, which are components of the control device 100B, are also connected to the bus 105.

The processor 110a is configured using a calculation core, a cache memory, a direct memory access (DMA), and the like. The processor 110a executes processing related to data transfer performed among the communication I/F 130a, the memory module 120a, and the drive I/F 140a in response to a data I/O request transmitted from the external apparatus 2 via the communication I/F 130a.

The communication I/F 130a communicates with the external apparatus 2 via the communication network 5. The communication I/F 130a receives the data I/O request transmitted from the external apparatus 2, and transfers the received data I/O request and write data transmitted together with the data I/O request to the processor 110a. The communication I/F 130a receives data (for example, data read from the memory device 17 (memory drive 171)) transmitted from the processor 110a and transmits the received data to the external apparatus 2.

The memory module 120a is, for example, a dual in-line memory module (DIMM), and is configured using a volatile memory element such as a dynamic random access memory (DRAM). The memory module 120a stores, for example, various programs and various kinds of data used to implement functions of the storage apparatus 10.

The drive I/F 140a executes processing related to data transfer with the memory device 17 when data is read from the memory device 17 to the memory module 120a or data is written from the memory module 120a to the memory device 17.

The control microcomputer 150 includes a processor (CPU, MPU, or the like), a memory device (DRAM, RAM, or the like), a communication I/F, and the like, and functions as an information processing device (calculation device). The control microcomputer 150 communicates with components provided in the control device 100A and the control device 100B via the bus 105. Further, the control microcomputer 150 communicates with cooling fans 71a to 71f and a temperature sensor, which will be described later, via the bus 105 or another communication method (direct line, serial communication method, serial peripheral interface (SPI), inter-integrated circuit (I2C), or the like).

Functions of the control microcomputer 150 may be implemented by, for example, a device (for example, a service processor (SVP)) that performs overall monitoring, control, and the like for various kinds of hardware and various kinds of software provided in the communication I/F 130a, the processor 110a, the drive I/F 140a, and the storage apparatus 10.

The backup device 160 includes a device (a semiconductor storage device (SSD), a hard disk drive (HDD), or the like) that provides a nonvolatile memory area. The control microcomputer 150 copies (backs up) data stored in the memory module 120a and the memory module 120b to the backup device 160 when a power supply to components of the storage apparatus 10 other than the backup device 160 is stopped (hereinafter, referred to as “during a power failure”). Components of the control unit 50 including the backup device 160 can receive a power supply from an emergency power supply (for example, a battery (storage battery) or an uninterruptible power system (UPS)) for a predetermined time during a power failure or the like.

The memory device 17 includes one or more memory drives 171 that are recording media for providing physical memory areas. The memory drive 171 is configured using, for example, a nonvolatile recording medium such as a semiconductor storage device (SSD) or a hard disk drive (HDD).

The control device 100A, the control device 100B, the control microcomputer 150, and the backup device 160, which are components of the storage apparatus 10, are housed in the same housing. Hereinafter, all components including the housing and components housed in the housing are referred to as the “control unit 50”.

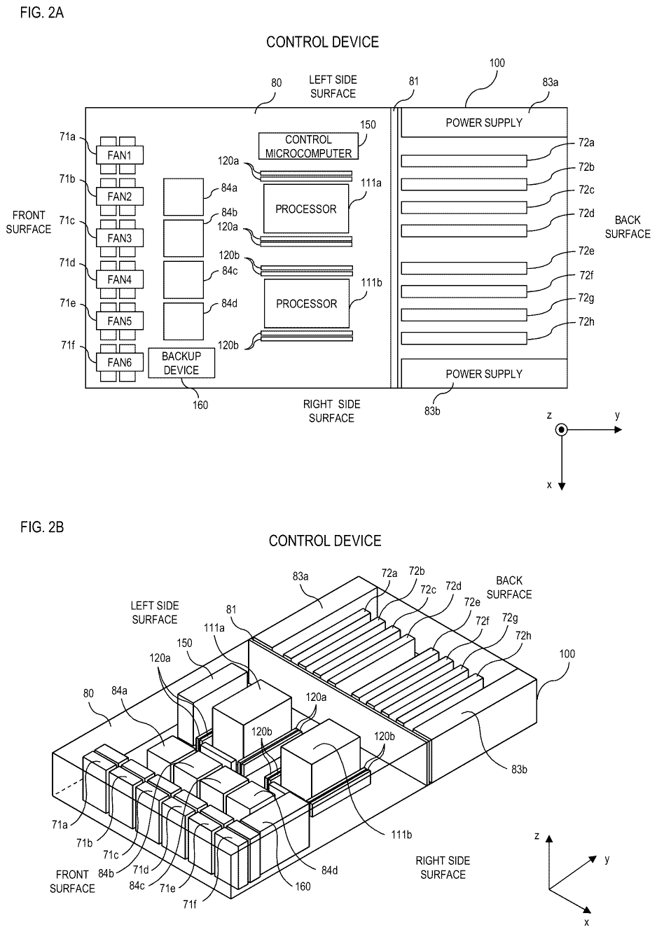

FIGS. 2A and 2B illustrate a configuration of the control device 100 (the control device 100A, the control device 100B). The illustrated control device 100 has a substantially rectangular parallelepiped shape having six surfaces (front surface, back surface, top surface, bottom surface, left side surface, and right side surface). The control device 100 is configured based on a frame made of a highly rigid material. Each of the six surfaces of the control device 100 may be closed by a panel (plate material) or may be opened to ensure air permeability, accessibility, and the like inside the control device 100.

Hereinafter, a three-dimensional coordinate system is used to specify positions (arrangement positions) of the components in the control device 100. Specifically, an x axis is set in the coordinate system such that a direction from the left side surface to the right side surface in a width direction of the control device 100 is +. Further, a y axis is set such that a direction from the front surface to the back surface in a depth direction of the control device 100 is +. Further, a z axis is set such that a direction from the bottom surface to the top surface in a height direction of the control device 100 is +. FIG. 2A is a plan view of the control device 100 as viewed from above (+z direction), and FIG. 2B is a perspective view of the control device 100 as viewed from the +x direction (right), the −y direction (front), and the +z direction (upper).

As illustrated in the drawing, two processors 111 (processor 111a and processor 111b) described above are arranged side by side in an x-axis direction near the center of the control device 100 in a y-axis direction. Both of the two processors 111 are mounted on a circuit board 80 fixed to the bottom surface of the control device 100. The processor 111a and the processor 111b may be provided with heat dissipation fans.

The memory modules 120a described above are arranged side by side on the −x side and the +x side of the processor 111a. The memory modules 120b described above are arranged side by side on the −x side and the +x side of the processor 111b. Both the memory module 120a and the memory module 120b are mounted on the circuit board 80 fixed to the bottom surface of the control device 100. The memory module 120a and the memory module 120b may be provided with heat dissipation fans.

The control microcomputer 150 is provided on the −x side of the processor 111a near the center of the control device 100 in the y-axis direction. The control microcomputer 150 is mounted on the circuit board 80.

In the control device 100, six cooling fans (hereinafter, cooling fans 71a to 71f) are arranged side by side in the x direction on the −y side (closer to the front surface) of a position where the processor 111a, the processor 111b, and the control microcomputer 150 are provided. The cooling fans 71a to 71f are mounted on the circuit board 80 directly or indirectly via a child board. Each of the exemplified cooling fans 71a to 71f has a double structure in which two cooling fans are connected in series such that directions of rotation axes thereof coincide with each other (hereinafter, a fan on a front surface side is referred to as an “inlet” and a fan on a rear surface side is referred to as an “outlet”).

In the control device 100, eight I/O modules 72a to 72h are arranged side by side in the x direction on the +y side of a position where the processor 111a, the processor 111b, and the control microcomputer 150 are provided. The I/O modules 72 include modules and circuits that function as the communication I/F 130a and the drive I/F 140b described above. Each of the I/O modules 72a to 72h is mounted on one of sockets provided on a backboard 81 fixed parallel to the x-axis direction slightly closer to the back surface than the center of the control device 100 in the y-axis direction.

Four heat sink 84a to 84d are arranged side by side in the x direction between the cooling fans 71a to 71f, and the processor 111a, the processor 111b, the control microcomputer 150. The heat sink 84a to 84d are mounted on the circuit board 80 directly or indirectly via a child board.

The control device 100 includes two power supplies (including an AC/DC converter, a DC/DC converter, and the like. Hereinafter, referred to as a “power supply 83a” and a “power supply 83b”) that respectively supply power to components of the control unit 50 on the +x side (near the left side surface) and the −x side (near the right side surface) of the I/O modules 72a to 72h.

Although not illustrated, a plurality of temperature sensors that output measured values of an outside air temperature, an inside temperature of the control device 100, and temperatures of components (the processor 111a and the processor 111b, the cooling fans 71a to 71f, the I/O modules 72a to 72h, the power supplies 83a and 83b, and the like) in real time are provided at important points of the control device 100.

The backup device 160 is provided in the control device 100 on the +y side of the cooling fans 71a to 71f and on the +x side of the heat sink 84a to 84d.

Although not illustrated, an emergency power supply (a battery (storage battery), a UPS, or the like) that supplies power to components of the control device 100 during a power failure is connected to the control device 100. The emergency power supply may be provided inside the control device 100.

### Connection Relationship Around Control Microcomputer

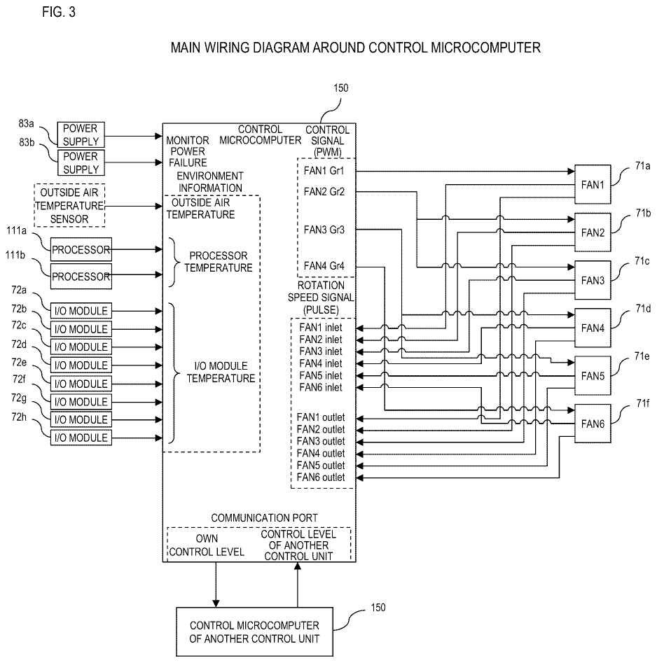

FIG. 3 illustrates a main connection relationship around the control microcomputer 150 (wiring diagram). The control microcomputer 150 has an input terminal (power failure monitoring) that receives power failure monitoring information transmitted from the power supplies 83a and 83b, and an input terminal (outside air temperature) that receives an output of an outside air temperature sensor.

The control microcomputer 150 has an input terminal that receives information (hereinafter, referred to as “environment information”) indicating a current temperature inside or outside the control device 100, which is acquired based on a measured value of the temperature sensor.

Specifically, the control microcomputer 150 has input terminals (processor temperatures) that receive outputs of temperature sensors provided in the processor 111a and the processor 111b.

The control microcomputer 150 has input terminals (I/O module temperatures) that receives outputs of temperature sensors provided in the I/O modules 72a to 72h.

The control microcomputer 150 has input terminals (“FAN1 inlet” to “FAN6 inlet”, “FAN1 outlet” to “FAN6 outlet”) that receive measured values of rotation speeds of the cooling fans 71a to 71f.

Further, the control microcomputer 150 has output terminals (“FAN Gr1” to “FAN Gr4”) that output control signals (PWM signals) for controlling the rotation speeds of the cooling fans 71a to 71f.

The control microcomputer 150 has a communication port for communicating with the control microcomputer 150 of the other control device 100. The control microcomputer 150 transmits an own control level, which will be described later, to the control microcomputer 150 of the other control device 100 via the communication port. The control microcomputer 150 receives a current control level of the control microcomputer 150 of the other control device 100 from the control microcomputer 150 of the other control device 100 via the communication port.

### Rotation Speed Control

The control microcomputer 150 controls the rotation speeds of the cooling fans 71a to 71f according to the environment information and positions where the cooling fans 71a to 71f are provided (positions corresponding to main cooling objects (components) of the cooling fans 71a to 71f). The control microcomputer 150 controls the rotation speeds of the cooling fans 71a to 71f by a pulse width modulation (PWM) method.

The control microcomputer 150 controls the rotation speeds of the cooling fans 71a to 71f in units of groups into which the cooling fans 71a to 71f are classified.

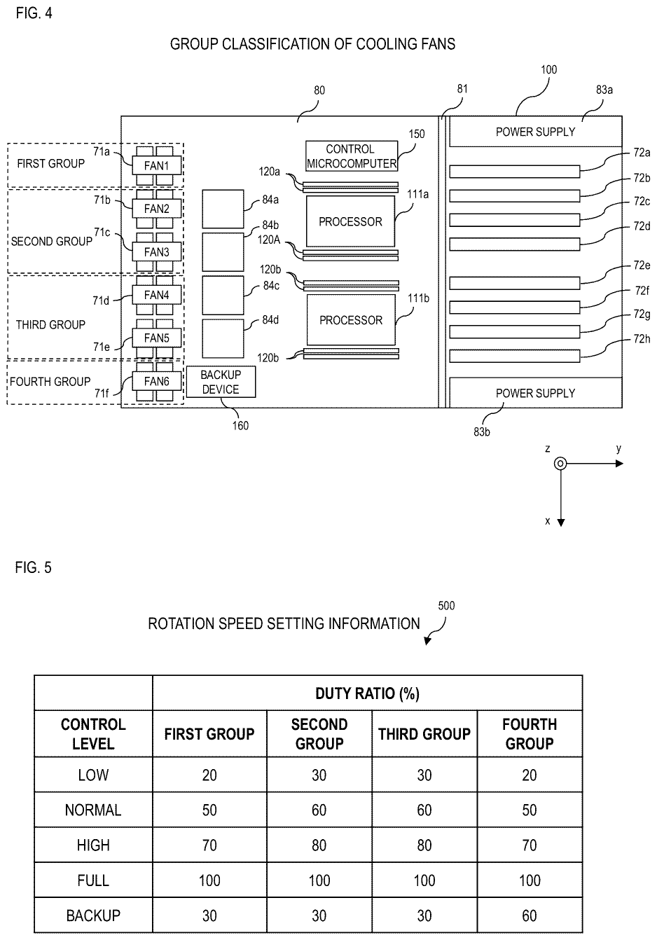

As illustrated in FIG. 4, in the present embodiment, the cooling fan 71a is classified into a first group, the cooling fan 71b and the cooling fan 71c are classified into a second group, the cooling fan 71d and the cooling fan 71e are classified into a third group, and the cooling fan 71f is classified into a fourth group. The control microcomputer 150 stores information indicating allocation of groups of the cooling fans 71a to 71f.

The control microcomputer 150 controls the rotation speeds of the cooling fans 71a to 71f by switching the cooling fans 71a to 71f to any one of five preset control levels (low speed (LOW), medium speed (NORMAL), high speed (HIGH), ultrahigh speed (FULL), and power failure (BACKUP)) in units of group.

FIG. 5 illustrates setting information (hereinafter referred to as “rotation speed setting information 500”) on a rotation speed for each control level of the cooling fans 71a to 71f, which is stored in the control microcomputer 150. As illustrated in the drawing, the rotation speed setting information 500 manages information indicating a rotation speed of the cooling fan 71 belonging to each group for each control level. A numerical value indicated in the rotation speed setting information 500 is a duty ratio.

As illustrated in the drawing, when the control level is any one of “low speed (LOW)”, “medium speed (NOMAL)”, and “high speed (HIGH)”, the cooling fan 71a belonging to the first group is controlled to have a lower rotation speed than the cooling fans 71b to 71e belonging to the second group and the third group in order to reduce power consumption and noise.

When the control level is “ultrahigh speed (FULL)”, all the cooling fans 71a to 71f are controlled to have a maximum rotation speed in order to maximize the cooling capability.

When the control level is “power failure (BACKUP)”, the cooling fan 71f belonging to the fourth group is controlled to have a higher rotation speed than the other cooling fans 71a to 71e in order to reliably cool the backup device 160 while reducing power consumption of all of the cooling fans 71.

When a difference in rotation speed between the cooling fans 71 arranged adjacent to each other is large, cooling air of the cooling fan 71 having a smaller rotation speed is suctioned toward cooling air of the cooling fan 71 having a larger rotation speed, and accordingly the cooling capability of the cooling fan 71 having a smaller rotation speed may be insufficient and the cooling capability for a cooling object may be insufficient. Therefore, in the rotation speed setting information 500 illustrated as an example, the duty ratio of the cooling fan 71 of each group is set such that the difference in rotation speed between the adjacent cooling fans 71 is not too large (in this example, the duty ratio is 10% or less) in any one of the control levels.

### Cooling Air Flow

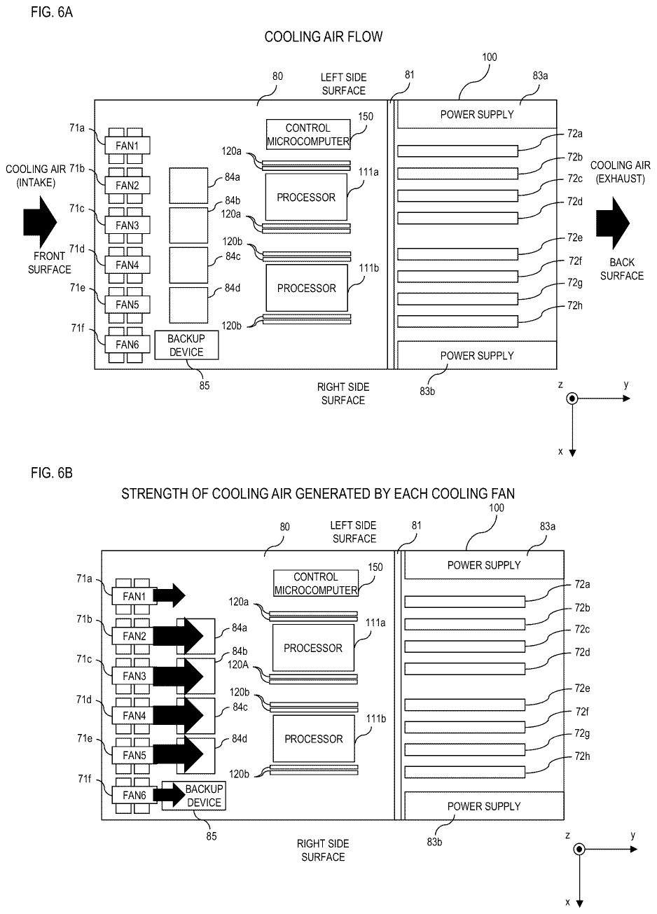

FIG. 6A illustrates a schematic flow of intake air and exhaust air of cooling air generated by the cooling fans 71a to 71f in the control device 100. As illustrated in the drawing, the cooling fans 71a to 71f take in outside air from the front surface of the control device 100 and guide the taken-in outside air into the control device 100.

The cooling air guided into the control device 100 is cooled and rectified by the heat sink dissipation fans 84a to 84d, and the rectified cooling air cools the processor 111a and the processor 111b, the memory module 120a and the memory module 120b, and the control microcomputer 150. Thereafter, the cooling air passes through holes provided in the backboard 81, a gap formed around the backboard 81, and the like, and flows into a region where the I/O modules 72a to 72h and the power supplies 83a and 83b are provided. The cooling air cools the I/O modules 72a to 72h and the power supplies 83a and 83b, and then is exhausted from the back surface of the control device 100.

FIG. 6B illustrates a relative strength of the cooling air generated by the cooling fans 71a to 71f.

As illustrated in the drawing, the cooling fan 71a of the first group generates cooling air for mainly cooling the control microcomputer 150.

The cooling fans 71b and 71c of the second group generate cooling air for mainly cooling the processor 111a and the memory module 120a.

The cooling fans 71d and 71e of the third group generate cooling air for mainly cooling the processor 111b and the memory module 120b.

The cooling fans 71f of the fourth group generates cooling air for mainly cooling the backup device 160.

The control unit 50 ensures high reliability by arranging the two control devices 100 (the control device 100A and the control device 100B) vertically and providing redundancy. However, in this case, when there is a difference in rotation speeds of the cooling fans 71a to 71f in a plurality of the control devices 100 arranged adjacent to each other, the following problem occurs.

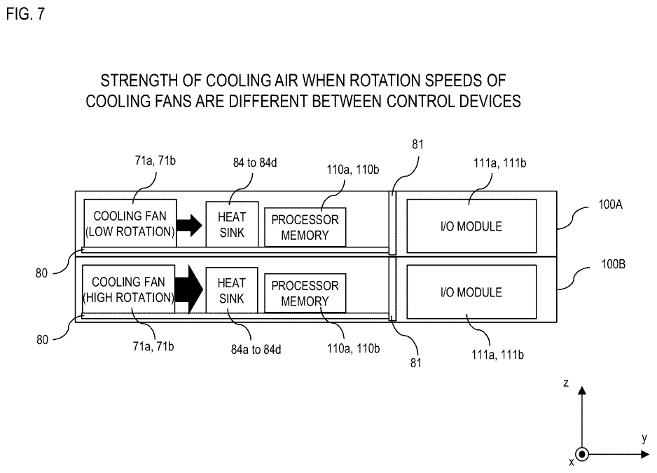

FIG. 7 is a diagram illustrating the problem described above, and is a diagram illustrating a state in which the two control devices 100 (the control device 100A and the control device 100B) are stacked vertically (sides of the control devices 100 in the x direction and sides of the control devices 100 in the y direction are aligned and sides are overlapped in the z-axis direction) when viewed from the +x direction. In the drawing, a strength of cooling air is indicated by an arrow.

As illustrated in the drawing, when there is a difference in the rotation speeds of the cooling fans 71a to 71f in the two control devices of the control device 100A and the control device 100B arranged adjacent to each other, the cooling air of the cooling fans 71a to 71f in the control device 100A on a low rotation speed side is suctioned by negative pressure generated by the cooling air of the control device 100B on a high rotation speed side, and cooling of the control device 100A may be insufficient.

Therefore, in the present embodiment, the control microcomputer 150 shares a current control level with the control microcomputer 150 of the adjacent other control device 100, and the control microcomputer 150 of the control device 100 performs control such that a difference between the control level of the control microcomputer 150 and the control level of the control microcomputer 150 of the other control device 100 does not exceed a preset number of levels.

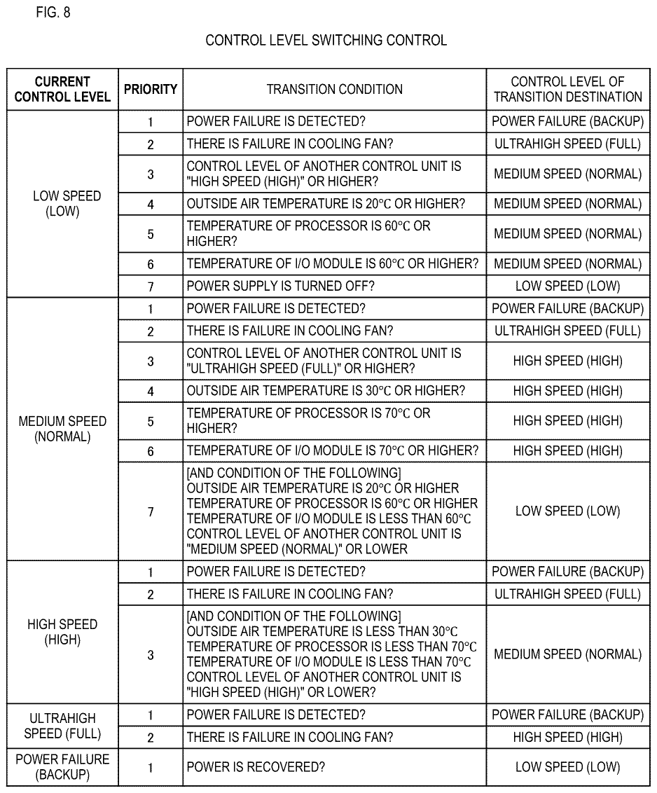

FIG. 8 is a diagram illustrating control related to switching (hereinafter, also referred to as “transition”) of control levels performed by the control microcomputers 150 of the two control devices 100 (the control device 100A and the control device 100B).

The control microcomputer 150 determines a control level of a transition destination by determining a transition condition set for each control level as needed (for example, in real time, and every time a predetermined timing arrives) according to a priority of each transition condition, and switches the control level to the determined transition destination. The “switching” of the control level in the present embodiment includes a case where a current control level is maintained as a result of the determination.

As illustrated in the drawing, for example, when the current control level is “low speed (LOW)”, the control microcomputer 150 sequentially determines whether a transition condition is satisfied according to a priority, and switches the current control level to a control level set as the transition destination for the satisfied transition condition.

For example, when the current control level is “low speed (LOW)”, the control microcomputer 150 sequentially determines, according to a priority, whether transition conditions are satisfied, for example, “whether a power failure is detected”, “whether there is a failure (abnormality) in a cooling fan”, “whether there is a difference from a control level of the other control unit (whether a control level of the other control unit is “high speed (HIGH) or higher)”, “whether the outside air temperature is 20° C. or higher”, “whether a temperature of a processor is 60° C. or higher”, “whether a temperature of an I/O module is 60° C. or higher”, and “whether a power supply is turned off”, and when a transition condition is satisfied, the control microcomputer 150 switches an own control level to a control level set as a transition destination for the satisfied transition condition.

As described above, the control microcomputer 150 controls the cooling capability of the cooling fans 71a to 71f according to operation states of components to be cooled by the cooling fans 71a to 71f.

Processing Example

Next, processing (hereinafter, referred to as “fan control processing S900”) in which the control microcomputer 150 controls the cooling fans 71a to 71f according to the switching control method illustrated in FIG. 8 will be described. Hereinafter, as illustrated in FIG. 7, a case where the two control devices 100 (the control device 100A and the control device 100B) are stacked vertically and the control microcomputers 150 are communicably connected will be described as an example.

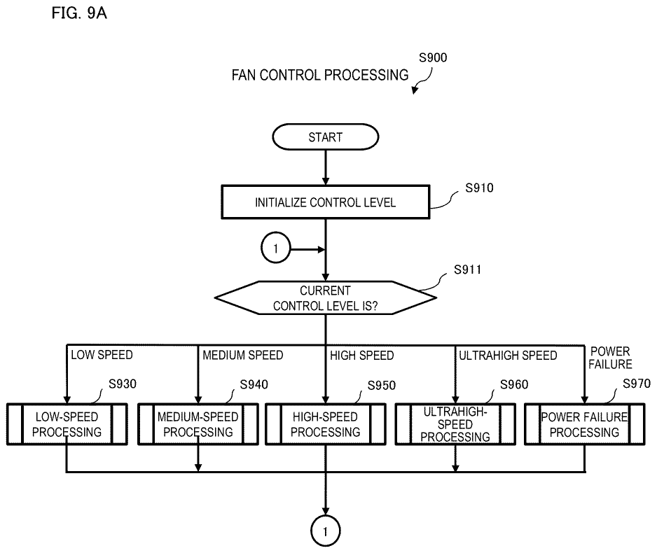

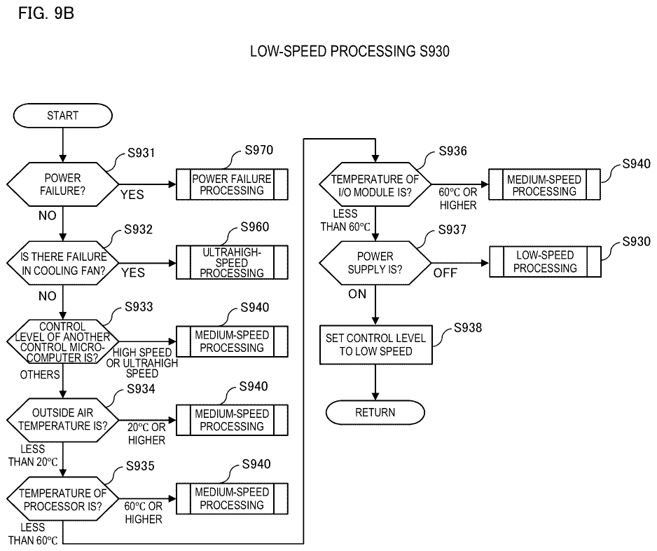

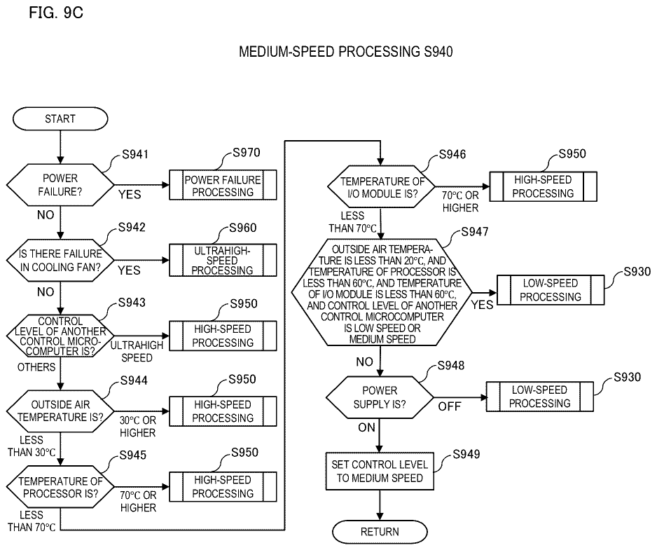

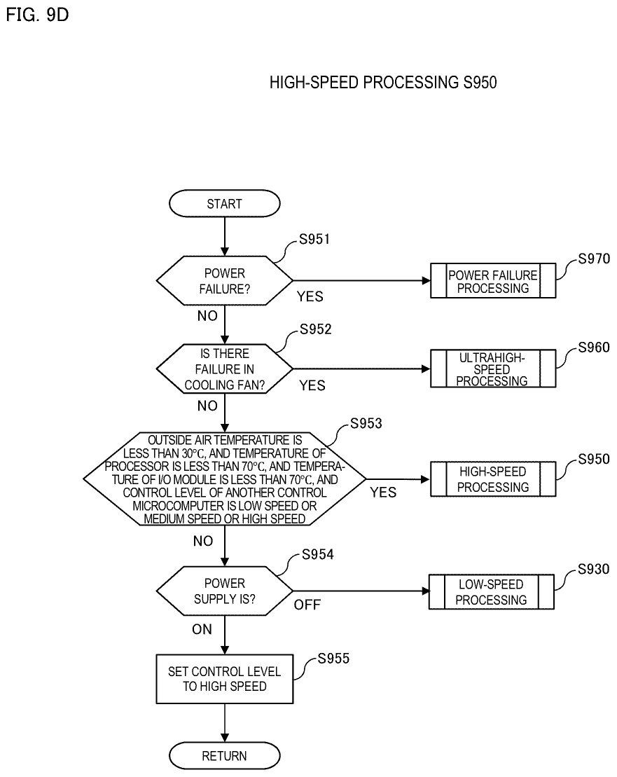

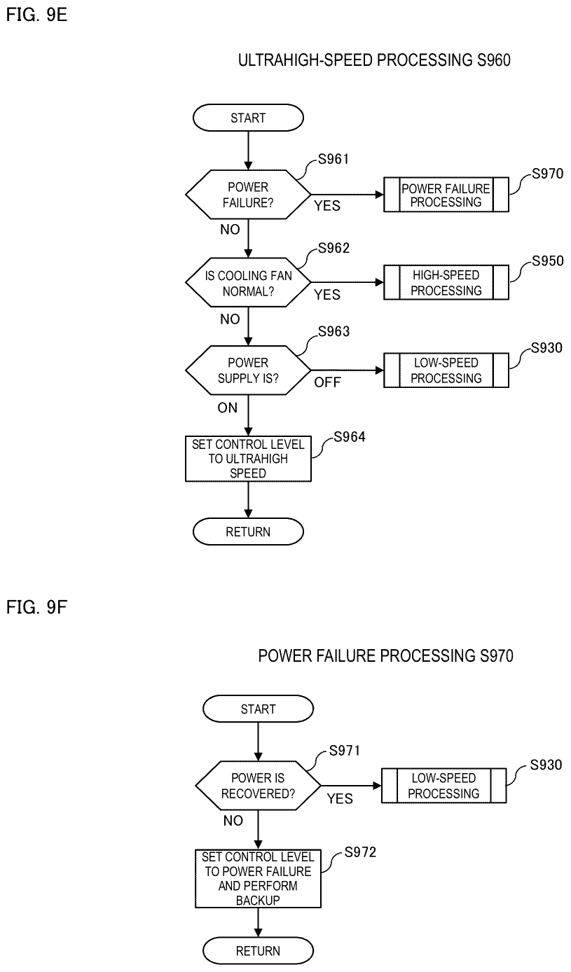

FIG. 9A is a flowchart illustrating the fan control processing S900. The control microcomputers 150 of the two control devices 100 individually execute the fan control processing S900 in the control of the cooling fans 71a to 71f. Since processing executed by the control microcomputers 150 of the two control devices 100 is the same, the fan control processing S900 executed by the control microcomputer 150A of the control device 100A will be described below.

As illustrated in the drawing, first, when the storage apparatus 10 is started up (except when a power supply is restored within a predetermined time from a power failure), the control microcomputer 150A initializes a control level (in this example, sets the control level to “low speed (LOW)”) (S910), and starts control of the cooling fans 71a to 71f at the initialized control level.

Subsequently, the control microcomputer 150A acquires an own current control level (S911), and executes processing (any one of low-speed processing S930, medium-speed processing S940, high-speed processing S950, ultrahigh-speed processing S960, and power failure processing S970) according to the acquired control level. Each of the above processing according to the control level corresponds to contents of each control level illustrated in FIG. 8.

FIG. 9B is a flowchart illustrating the low-speed processing S930.

As illustrated in the drawing, first, the control microcomputer 150A determines whether there is a power failure at present (S931). When it is determined that there is a power failure (S931: YES), the control microcomputer 150A executes processing illustrated in FIG. 9F (hereinafter referred to as the “power failure processing S970”).

On the other hand, when it is determined that there is no power failure (S931: NO), the control microcomputer 150A subsequently determines whether there is a failure in at least one of the cooling fans 71a to 71f (S932). When it is determined that there is a failure in at least one of the cooling fans 71a to 71f (S932: YES), the control microcomputer 150A executes processing illustrated in FIG. 9E (hereinafter referred to as the “ultrahigh-speed processing S960”).

On the other hand, when it is determined that there is no failure in any one of the cooling fans 71a to 71f (S932: NO), the control microcomputer 150A subsequently determines whether a current control level of the control microcomputer 150B of the control device 100B is “high speed (HIGH)” or “ultrahigh speed (FULL)” (whether a difference between the control levels is two or more levels) (S933). When it is determined that the control level of the control microcomputer 150B is “high speed (HIGH)” or “ultrahigh speed (FULL)” (S933: high speed or ultrahigh speed), the control microcomputer 150A executes processing illustrated in FIG. 9C (hereinafter, referred to as the “medium-speed processing S940”) in order to reduce the difference in control level.

On the other hand, when it is determined that the current control level of the control microcomputer 150B is not “high speed (HIGH)” or “ultrahigh speed (FULL)” (S933: others), the control microcomputer 150 subsequently determines whether the outside air temperature is 20° C. or higher (S934). When it is determined that the outside air temperature is 20° C. or higher (S934: 20° C. or higher), the control microcomputer 150A executes the medium-speed processing S940 illustrated in FIG. 9C.

On the other hand, when it is determined that the outside air temperature is lower than 20° C. (S934: lower than 20° C.), the control microcomputer 150 subsequently determines whether a temperature of the processor 110a or the processor 111b is 60° C. or higher (S935). When it is determined that the temperature of the processor 110a or the processor 111b is 60° C. or higher (S935: 60° C. or higher), the control microcomputer 150A executes the medium-speed processing S940 illustrated in FIG. 9C.

On the other hand, when it is determined that the temperature of the processor 110a or the processor 111b is lower than 60° C. (S935: lower than 60° C.), the control microcomputer 150A subsequently determines whether a temperature of at least one of the I/O modules 72a to 72h is 60° C. or higher (S936). When it is determined that the current temperature of at least one of the I/O modules 72a to 72h is 60° C. or higher (S936: 60° C. or higher), the control microcomputer 150A executes the medium-speed processing S940 illustrated in FIG. 9C.

On the other hand, when it is determined that the temperature of each of the I/O modules 72a to 72h is lower than 60° C. (S936: lower than 60° C.), the control microcomputer 150 subsequently determines whether a power supply (the power supply 83a and the power supply 83b) is turned off (S937). When it is determined that the power supply is turned off (S937: OFF), the control microcomputer 150A executes the low-speed processing S930.

On the other hand, when it is determined that the power supply is not turned off (S937: ON), the control microcomputer 150 sets the control level to “low speed (LOW)” and ends the low-speed processing S930 (the processing returns to S911 in FIG. 9A).

FIG. 9C is a flowchart illustrating the medium-speed processing S940.

In the medium-speed processing S940, first, the control microcomputer 150A determines whether there is a power failure at present (S941). When it is determined that there is a power failure (S941: YES), the control microcomputer 150 executes the power failure processing S970 illustrated in FIG. 9F.

On the other hand, when it is determined that there is no power failure (S941: NO), the control microcomputer 150A subsequently determines whether there is a failure in at least one of the cooling fans 71a to 71f (S942). When there is a failure in at least one of the cooling fans 71a to 71f (S942: YES), the control microcomputer 150A executes the ultrahigh-speed processing S960 illustrated in FIG. 9E.

On the other hand, when it is determined that there is no failure in any one of the cooling fans 71a to 71f (S942: NO), the control microcomputer 150A subsequently determines whether the current control level of the control microcomputer 150B of the control device 100 is “ultrahigh speed (FULL)” (S943). When it is determined that the current control level of the control microcomputer 150B is “ultrahigh speed (FULL)” (S943: ultrahigh speed), the control microcomputer 150A executes the high-speed processing S950 illustrated in FIG. 9D.

On the other hand, when it is determined that the acquired control level is not “ultrahigh speed (FULL)” (S943: others), the control microcomputer 150A subsequently determines whether the outside air temperature is 30° C. or higher (S944). When it is determined that the outside air temperature is 30° C. or higher (S944: 30° C. or higher), the control microcomputer 150A executes the high-speed processing S950 illustrated in FIG. 9D.

On the other hand, when it is determined that the outside air temperature is lower than 30° C. (S944: lower than 30° C.), the control microcomputer 150A subsequently determines whether a current temperature of the processor 110a or the processor 111b is 70° C. or higher (S945). When it is determined that the current temperature of the processor 110a or the processor 111b is 70° C. or higher (S945: 70° C. or higher), the control microcomputer 150A executes the high-speed processing S950 illustrated in FIG. 9D.

On the other hand, when it is determined that the temperature of the processor 110a or the processor 111b is lower than 70° C. (S945: lower than 70° C.), the control microcomputer 150A subsequently determines whether a temperature of at least one of the I/O modules 72a to 72h is 70° C. or higher (S946). When it is determined that the temperature of at least one of the I/O modules 72a to 72h is 70° C. or higher (S946: 70° C. or higher), the control microcomputer 150 executes the high-speed processing S950 illustrated in FIG. 9D.

On the other hand, when it is determined that the temperature of each of the I/O modules 72a to 72h is lower than 70° C. (S946: lower than 70° C.), the control microcomputer 150A subsequently determines whether a determination condition that the outside air temperature is lower than 20° C., the temperature of each of the processor 110a and the processor 111b is lower than 60° C., the temperature of each of the I/O modules 72a to 72h is lower than 60° C., and the control level of the control microcomputer 150B of the control device 100B is “low speed (LOW)” or “medium speed (NORMAL)” is satisfied (S947). When it is determined that the determination condition is satisfied (S947: YES), the control microcomputer 150A executes the low-speed processing S930.

On the other hand, when it is determined that the determination condition is not satisfied (S947: NO), the control microcomputer 150A subsequently determines whether a power supply (the power supply 83a and the power supply 83b) is turned off (S948). When it is determined that the power supply is turned off (S948: OFF), the control microcomputer 150A executes the low-speed processing S930.

On the other hand, when it is determined that the power supply is not turned off (S948: ON), the control microcomputer 150A sets the control level to “medium speed (NORMAL)” (S949), and ends the medium-speed processing S940 (the processing returns to S911 in FIG. 9A).

FIG. 9D is a flowchart illustrating the high-speed processing S950.

In the high-speed processing S950, first, the control microcomputer 150A determines whether there is a power failure at present (S951). When it is determined that there is a power failure (S951: YES), the control microcomputer 150A executes the power failure processing S970 illustrated in FIG. 9F.

On the other hand, when it is determined that there is no power failure (S951: NO), the control microcomputer 150 subsequently determines whether there is a failure in at least one of the cooling fans 71a to 71f (S952). When there is a failure in at least one of the cooling fans 71a to 71f (S952: YES), the control microcomputer 150A executes the ultrahigh-speed processing S960 illustrated in FIG. 9E.

On the other hand, when it is determined that there is no failure in any one of the cooling fans 71a to 71f (S952: NO), the control microcomputer 150A subsequently determines whether a determination condition that the outside air temperature is lower than 30° C., the temperature of each of the processor 110a and the processor 111b is lower than 70° C., the temperature of each of the I/O modules 72a to 72h is lower than 70° C., and the control level of the control microcomputer 150B of the control device 100B is “low speed (LOW)” or “medium speed (NOMAL)” is satisfied (S953). When it is determined that the determination condition is satisfied (S953: YES), the processing returns to S951.

On the other hand, when it is determined that the determination condition is not satisfied (S953: NO), the control microcomputer 150A subsequently determines whether a power supply (the power supply 83a and the power supply 83b) is turned off (S954). When it is determined that the power supply is turned off (S954: OFF), the control microcomputer 150A executes the low-speed processing S930.

On the other hand, when it is determined that the switch is not turned off (S954: ON), the control microcomputer 150A sets the control level to “high speed (HIGH)” (S955), and ends the high-speed processing S950 (the processing returns to S911 in FIG. 9A).

FIG. 9E is a flowchart illustrating the ultrahigh-speed processing S960.

In the ultrahigh-speed processing S960, first, the control microcomputer 150A determines whether there is a power failure at present (S961). When it is determined that there is a power failure (S961: YES), the control microcomputer 150A executes the power failure processing S970 illustrated in FIG. 9F.

On the other hand, when it is determined that there is no power failure (S961: NO), the control microcomputer 150A subsequently determines whether there is a failure in at least one of the cooling fans 71a to 71f (S962). When it is determined that there is no failure in any one of the cooling fans 71a to 71f (S962: YES), the control microcomputer 150A executes the high-speed processing S950 illustrated in FIG. 9D.

On the other hand, when it is determined that there is a failure in at least one of the cooling fans 71a to 71f (S962: NO), the control microcomputer 150A subsequently determines whether a power supply (the power supply 83a and the power supply 83b) is turned off (S963). When it is determined that the power supply is turned off (S963: OFF), the control microcomputer 150A executes the low-speed processing S930.

On the other hand, when it is determined that the power supply is not turned off (S963: ON), the control microcomputer 150A sets the control level to “ultrahigh speed (FULL)” (S964), and ends the ultrahigh-speed processing S960 (the processing returns to S911 in FIG. 9A).

FIG. 9F is a flowchart illustrating the power failure processing S970.

In the power failure processing S970, first, the control microcomputer 150A determines whether power is recovered (power failure is resolved) (S971). When it is determined that power is recovered (S971: YES), the control microcomputer 150A executes the low-speed processing S930.

On the other hand, when it is determined that power is not recovered (power failure continues) (S971: NO), the control microcomputer 150 acquires a backup of information stored in the memory module 120a and the memory 102B and transmits the backup to the backup device 160 (S972), and then ends the fan control processing 900.

### Overview

As described above, in the storage apparatus 10 according to the present embodiment, the control microcomputer 150 (information processing device) acquires the environment information that is information on an environment inside or around the control device 100, which is acquired based on an output of a temperature sensor, and controls rotation speeds of the cooling fans 71a to 71f based on the environment information and positions where the cooling fans 71a to 71f are provided (positions corresponding to main cooling objects (components) of the cooling fans 71a to 71f).

Therefore, the cooling fans 71a to 71f can be efficiently and appropriately controlled according to the environment information (temperature outside the housing and temperatures of components), and power consumption and noise can be reduced.

The control microcomputer 150 controls the rotation speeds of the cooling fans 71a to 71f according to operation states of components to be cooled by the cooling fans 71a to 71f.

As described above, since the control microcomputer 150 controls the rotation speeds of the cooling fans 71a to 71f according to the operation states (heat generation state, heat generation amount, and the like) of the components to be cooled by the cooling fans 71a to 71f, the cooling fans 71a to 71f can be efficiently and appropriately controlled, and power consumption and noise can be reduced.

The control microcomputer 150 increases the rotation speed of at least one of the cooling fans 71a to 71f when at least one of the temperature outside the control device 100 and the temperatures of the components is equal to or higher than a preset temperature.

Therefore, a temperature rise of the components can be efficiently prevented, and power consumption and noise can be reduced because the rotation speed of the cooling fan 71 is not unnecessarily increased.

Further, the control microcomputer 150 controls the rotation speeds of the cooling fans 71a to 71f such that a difference in rotation speed among the cooling fans 71a to 71f falls within a preset range.

Therefore, cooling capability of the cooling fans 71a to 71f can be prevented from becoming insufficient due to interference of cooling air among the cooling fans 71a to 71f.

When the two control devices 100 (the control device 100A and the control device 100B) are arranged adjacent to each other, the control microcomputer 150A of the control device 100A is communicably connected to the control microcomputer 150B of the control device 100B, acquires information (control level) indicating the rotation speeds of the cooling fans 71a to 71f of the control device 100B from the control microcomputer 150B, and controls the rotation speeds (control level) of the cooling fans 71a to 71f of the control device 100A such that a difference between the acquired rotation speeds (control level) of the cooling fans 71a to 71f of the control device 100B and the rotation speeds (control level) of the cooling fans 71a to 71f of the control device 100A falls within a preset range.

Therefore, the cooling capability of the cooling fans 71a to 71f of the control device 100A can be prevented from becoming insufficient due to the influence of the cooling fans 71a to 71f of the other control device 100B.

The control microcomputer 150 monitors the presence or absence of an abnormality in each of the cooling fans 71a to 71f, and increases the rotation speeds of all the cooling fans 71a to 71f when an abnormality is detected in at least one of the cooling fans 71a to 71f.

Therefore, when an abnormality occurs in the cooling fan 71, the cooling capability for each component can be prevented from becoming insufficient.

The control microcomputer 150 increases the rotation speed of the cooling fan 71f that generates cooling air for cooling the backup device 160 at the time of a power failure.

Therefore, the cooling capability of the backup device 160 can be prevented from becoming insufficient when data is copied from the memory module 120 to the backup device 160 during a power failure.

The control microcomputer 150 classifies the cooling fans 71a to 71f into a plurality of groups, and controls the rotation speeds of the cooling fans 71a to 71f in units of group.

Therefore, the control of the cooling fans 71a to 71f can be simplified.

Although embodiments have been described above, the invention is not limited to the above-described embodiments, the invention includes various modifications, and is not necessarily limited to those including all the configurations described above.

What is claimed is:

1. A storage apparatus that inputs and outputs data to and from a memory drive in response to an input and output request transmitted from an external apparatus, the storage apparatus comprising:
a housing configured to house components;
a plurality of cooling fans provided at a plurality of locations of the housing so as to cool at least one of the components; and
an information processing device configured to control the plurality of cooling fans, wherein
the information processing device
acquires environment information that is information on an environment inside or around the housing, and
controls rotation speeds of the cooling fans based on the environment information and positions where the cooling fans are provided.

2. The storage apparatus according to claim 1, wherein
the information processing device controls the rotation speeds of the cooling fans according to operation states of the components to be cooled by the cooling fans.

3. The storage apparatus according to claim 1, wherein
the information processing device includes a temperature sensor that measures at least one of a temperature outside the housing and a temperature of each of the components, and the environment information includes information based on an output of the temperature sensor.

4. The storage apparatus according to claim 3, wherein
the information processing device increases the rotation speed of at least one of the plurality of cooling fans when at least one of the temperature outside the housing and the temperature of each of the components is equal to or higher than a preset temperature.

5. The storage apparatus according to claim 1, wherein
the information processing device controls the rotation speeds of the cooling fans such that a difference in the rotation speeds of the plurality of cooling fans falls within a preset range.

6. The storage apparatus according to claim 1, wherein
the cooling fan is provided at a position where a cooling capability of the cooling fan is likely to be affected by cooling air generated by a cooling fan in another housing including the cooling fan, and
the information processing device
is communicably connected to another information processing device of the other housing,
acquires information indicating a rotation speed of the cooling fan in the other housing from the other information processing device, and
controls the rotation speed of the cooling fan in the housing such that a difference between the rotation speed of the cooling fan in the other housing and the rotation speed of the cooling fan in the housing falls within a preset range.

7. The storage apparatus according to claim 1, wherein
the information processing device monitors presence or absence of an abnormality in each of the plurality of cooling fans, and increases the rotation speeds of all the plurality of cooling fans when an abnormality is detected in at least one of the plurality of cooling fans.

8. The storage apparatus according to claim 1, wherein
the components include an input and output module including at least one of a communication interface that communicates with the external apparatus and a drive interface that inputs and outputs data to and from the memory drive, and a memory module that stores data exchanged with the communication interface and the drive interface.

9. The storage apparatus according to claim 8, wherein
the components are configured to receive a drive power supply from an emergency power supply during a power failure,
the memory module stores the data in a volatile memory area,
the components include a backup device having a nonvolatile memory area and communicably connected to the information processing device and the memory module,
data is copied from the memory module to the backup device during the power failure, and
the information processing device increases the rotation speed of the cooling fan that generates cooling air for cooling the backup device during the power failure.

10. The storage apparatus according to claim 1, wherein
the information processing device classifies the plurality of cooling fans into a plurality of groups, and
the information processing device controls the rotation speeds of the cooling fans in units of the groups.

11. A method for controlling a storage apparatus,
the storage apparatus inputting and outputting data to and from a memory drive in response to an input and output request transmitted from an external apparatus, and including a housing configured to house components of the storage apparatus, a plurality of cooling fans provided at a plurality of locations of the housing so as to cool at least one of the components, and an information processing device configured to control the plurality of cooling fans,
the method comprising:
executed by the information processing device,
acquiring environment information that is information on an environment inside or around the housing; and
controlling rotation speeds of the cooling fans based on the environment information and positions where the cooling fans are provided.

12. A program for an information processing device of a storage apparatus,
the storage apparatus inputting and outputting data to and from a memory drive in response to an input and output request transmitted from an external apparatus, and including a housing configured to house components of the storage apparatus, a plurality of cooling fans provided at a plurality of locations of the housing so as to cool at least one of the components, and the information processing device configured to control the plurality of cooling fans,
the program causing the information processing device to implement:
a function of acquiring environment information that is information on an environment inside or around the housing; and
a function of controlling rotation speeds of the cooling fans based on the environment information and positions where the cooling fans are provided.

13. The storage apparatus according to claim 2, wherein
the information processing device includes a temperature sensor that measures at least one of a temperature outside the housing and a temperature of each of the components, and the environment information includes information based on an output of the temperature sensor.

14. The storage apparatus according to claim 2, wherein
the information processing device controls the rotation speeds of the cooling fans such that a difference in the rotation speeds of the plurality of cooling fans falls within a preset range.

15. The storage apparatus according to claim 2, wherein
the cooling fan is provided at a position where a cooling capability of the cooling fan is likely to be affected by cooling air generated by a cooling fan in another housing including the cooling fan, and
the information processing device
is communicably connected to another information processing device of the other housing,
acquires information indicating a rotation speed of the cooling fan in the other housing from the other information processing device, and
controls the rotation speed of the cooling fan in the housing such that a difference between the rotation speed of the cooling fan in the other housing and the rotation speed of the cooling fan in the housing falls within a preset range.

16. The storage apparatus according to claim 2, wherein
the information processing device monitors presence or absence of an abnormality in each of the plurality of cooling fans, and increases the rotation speeds of all the plurality of cooling fans when an abnormality is detected in at least one of the plurality of cooling fans.

17. The storage apparatus according to claim 2, wherein
the components include an input and output module including at least one of a communication interface that communicates with the external apparatus and a drive interface that inputs and outputs data to and from the memory drive, and a memory module that stores data exchanged with the communication interface and the drive interface.

18. The storage apparatus according to claim 2, wherein
the information processing device classifies the plurality of cooling fans into a plurality of groups, and
the information processing device controls the rotation speeds of the cooling fans in units of the groups.
